(19) United States
(12) Patent Application Publication
(10) Pub. No.: US 2014/0289752 A1
(43) Pub. Date: Sep. 25, 2014

(54) SYSTEM AND METHOD FOR TEMPORAL RATING AND ANALYSIS OF DIGITAL CONTENT

(71) Applicant: ITTIAM SYSTEMS PTE. LTD., Singapore (SG)

(72) Inventors: SATTAM DASGUPTA, Bangalore (IN); Anil Kumar Agara Venkatesha Rao, Bangalore (IN)

(73) Assignee: ITTIAM SYSTEMS PTE. LTD., Singapore (SG)

(21) Appl. No.: 13/966,299

(22) Filed: Aug. 14, 2013

(30) Foreign Application Priority Data
Mar. 25, 2013 (IN) 1299/CHE/2013

(51) Int. Cl. H04N 21/442

(52) U.S. Cl. CPC H04N 21/44222
USPC 725/14

(57) ABSTRACT

A system and method for temporal rating and analysis of digital content in a temporally changing digital content environment are disclosed. In one embodiment, one or more end points, one or more content service providers, and a rating analytics server (RAS) are communicatively connected via a communication network. In one example, each of the end points includes a rating capture module (RCM). Further, the digital content is sent to the end points by the content service providers. Furthermore, temporal rating, inputs and/or reactions of consumers are dynamically captured, by the RCM, while viewing and/or listening to digital content on the end points. In addition, the captured temporal rating, inputs and/or reactions are sent to the RAS by the RCM. Also, the received temporal rating, inputs and/or reactions are analyzed and sent to the content service providers by the RAS.

Benefit is claimed under 35 U.S.C. 119(a) to Indian Provisional Patent Application Ser. No. 1299/CHE/2013 entitled “TEMPORAL RATING AND ANALYSIS OF DIGITAL CONTENT” by Ittiam Systems (P) Ltd. filed on Mar. 25, 2013.

### FIELD OF TECHNOLOGY

Embodiments of the present invention relate to digital content. More particularly, embodiments of the present invention relate to temporal rating and analysis of the digital content.

### BACKGROUND

In recent years, amount of content being shared by consumers, enterprises, government and other entities through social networking, collaboration, media sharing, Internet protocol television (IPTV), over-the-top (OTT) services, and the like is increased. Some of these services also provide a means for rating the content being shared. Typically, the rating is in terms of ‘likes’ for entire instance of the content that is being shared. With the advancement of compression technologies and storage capacity offered by the services, amount of digital content being shared that has a timeline i.e., the digital content changes with time is on the rise. This includes video streams, audio streams, graphics (e.g., games and the like), text (e.g., book reading, presentation and the like) and so on. Therefore, the above rating techniques may not be sufficient for temporally changing digital content environment.

### BRIEF DESCRIPTION OF THE DRAWINGS

Embodiments of the present invention are illustrated by way of an example and not limited to the figures of the accompanying drawings, in which like references indicate similar elements and in which:

FIG. 1A illustrates a block diagram of a connected digital content sharing system, in the context of the present invention;

FIG. 1B illustrates a block diagram of a system for temporal rating and analysis of digital content, where content service providers and end points for digital content play out and rating are communicatively connected, according to one embodiment;

FIG. 2A illustrates a block diagram of a digital content sharing system, in the context of the present invention;

FIG. 2B illustrates a block diagram of a system for temporal rating and analysis of the digital content, where one or more end points for rating the digital content and the content service providers are not communicatively connected, according to one embodiment;

FIG. 3 is a block diagram illustrating major functional sub-components of a rating capture module (RCM) residing in each of the end points, such as those shown in FIGS. 1B and 2B, according to one embodiment;

FIG. 4 is a block diagram illustrating major functional sub-components of a rating analytics server (RAS), such as the one shown in FIGS. 1B and 2B, according to one embodiment;

FIG. 5 is a table illustrating a rating criteria stored in the RCM, such as the one shown in FIG. 3, according to one embodiment;

FIG. 6 illustrates a process flow for temporal rating and analysis of digital content, according to one embodiment; and

FIG. 7 illustrates another process flow for temporal rating and analysis of the digital content, according to one embodiment.

Other features of the present embodiments will be apparent from the accompanying drawings and from the detailed description that follows.

### DETAILED DESCRIPTION

A system and method for temporal rating and analysis of digital content are disclosed. In the following detailed description of the embodiments of the invention, reference is made to the accompanying drawings that form a part hereof, and in which are shown, by way of illustration, specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

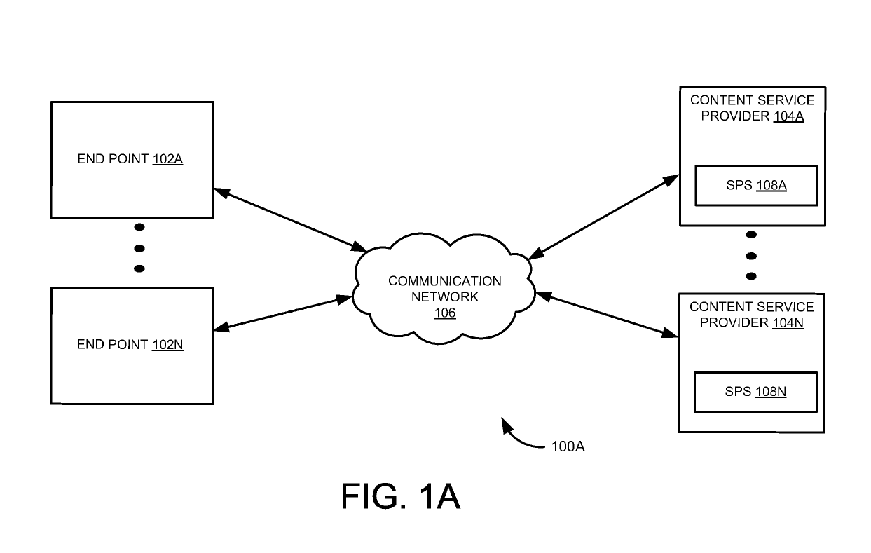

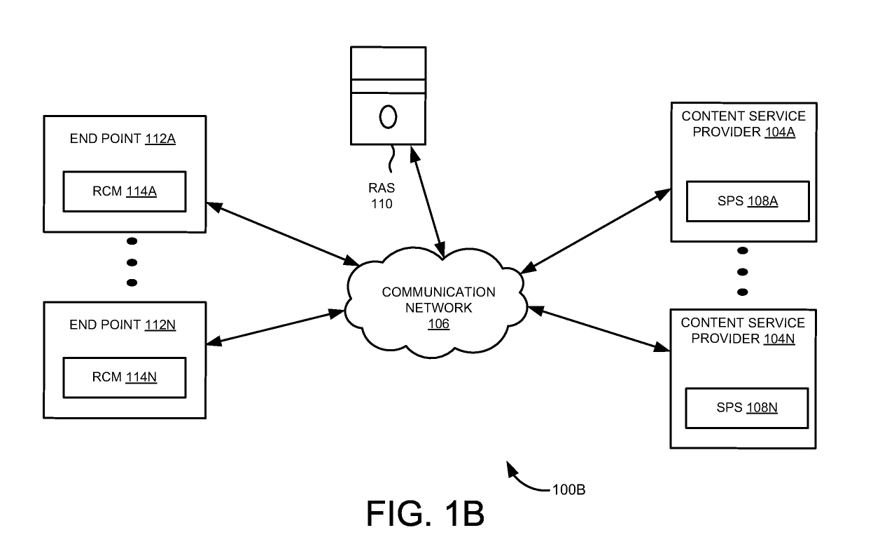

FIG. 1A illustrates a block diagram of a connected digital content sharing system 100A, in the context of the present invention. As shown in FIG. 1A, the system 100A includes a plurality of end points 102A-N and a plurality of content service providers 104A-N. Further, the content service providers 104A-N include service provider servers (SPSs) 108A-N. Furthermore, the end points 102A-N and the content service providers 104A-N are communicatively connected via a communication network 106. In operation, the digital content is sent to the end points 102A-N by the content service providers 104A-N via the communication network 106. Further in operation, consumers associated with the end points 102A-N rate the digital content for partially or the entire duration of time.

Referring now to FIG. 1B, which illustrates a block diagram of a system 100B for temporal rating and analysis of digital content, where the content service providers 104A-N and a plurality of end points 112A-N for the digital content play out and rating are communicatively connected, according to one embodiment. As shown in FIG. 1B, the system 100B includes the end points 112A-N, the content service providers 104A-N, and a rating analytics server (RAS) 110. For example, the end points 112A-N include a tablet, a mobile, a personal computer (PC), appliances, machines and gadgets (AMGs) with ability to consume digital content and the like. Further, the end points 112A-N include rating capture modules (RCMs) 114A-N. For example, a RCM is integrated into a standalone application or into content player applications in an end point. Furthermore, the content service providers 104A-N include the SPSs 108A-N. In addition, the end points 112A-N, the content service providers 104A-N and the RAS 110 are communicatively connected via the communication network 106. In one embodiment, the RAS 110 can be on a cloud based infrastructure and/or centralized/distributed.

In operation, each of the content service providers 104A-N send the digital content to the end points 112A-N. For example, the digital content includes audio streams, video streams, text, images, graphics and the like. Further, the RCMs 114A-N dynamically capture temporal rating, inputs and/or reactions of consumers while viewing and/or listening to the digital content on the end points 112A-N. For example, a rating service can be an independent one or integrated into content service providers offering. For example, the content service providers 104A-N include an Internet protocol television (IPTV) services provider, a social networking services provider, a video sharing services provider, a digital content sharing services provider, an audio/video communication/collaboration services provider and the like. In one example, the rating can be derived or inferred using cues from devices' available audio-visual and other input peripherals, from consumer reactions as they consume the digital content. An exemplary consumer reaction can be their attention span with respect to the digital content, derived through eye-tracking and/or duration a consumer spent watching a sequence and/or the number of times the sequence of the digital content is re-visited by the consumer. Another exemplary consumer reaction can be derived from their expressions like smile. The ratings can also be derived with respect to time over a longer range, such as a month/year to derive patterns of aspects that a consumer prefers. The same method can be used for consumer voting on different aspects of the digital content. The criteria and range of the rating can be set by the content service providers, as per their requirements. Optionally, the content service providers can also set one or more time windows in the duration of the digital content where the start and stop of a rating window can be enabled or triggered based on predefined criteria.

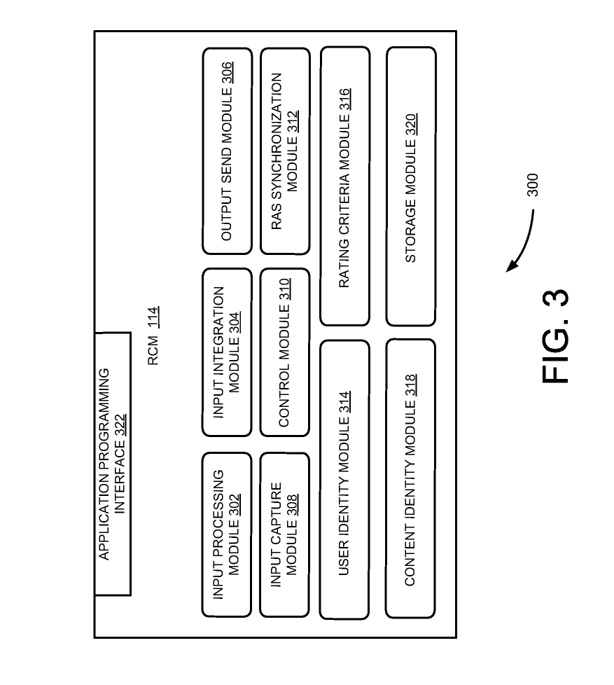

Furthermore, the RCMs 114A-N send the captured temporal rating, inputs and/or reactions to the RAS 110. This is explained in more detail with reference to FIG. 3. In one embodiment, some of the functionalities of the RCMs 114A-N can also be alternatively and/or additionally moved to the RAS 110 and/or to the SPSs 108A-N, where some of temporal information about consumption patterns can be extracted. For example, a video sharing service which fully or partially centralizes processing of control signals like trick-play in the SPSs 108A-N, the content usage pattern over time duration of the digital content can be derived by the SPSs 108A-N. Another example is an online e-book service where a duration of time spent on a particular page/a chapter of the book and other similar information can be derived by the SPSs 108A-N without any assistance from the end points 112A-N with the RCMs 114A-N. The information derived by the SPSs 108A-N can be sent to the RAS 110.

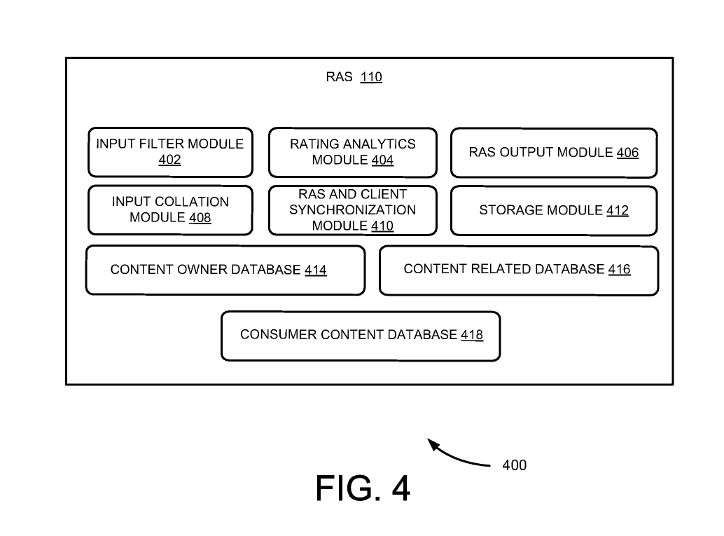

Moreover, the RAS 110 analyzes the received temporal rating, inputs and/or reactions and then sends the analyzed information to the content service providers 104A-N. This is explained in more detail with reference to FIG. 4. For example, the RAS 110 analyzes the received temporal rating, inputs and/or reactions based on different parameters of demography of the consumers. Exemplary parameters include an area of residence, an age-group and the like. In one embodiment, the RAS 110 real-time analyzes the received temporal rating, inputs and/or reactions and sends the analyzed information to the content service providers 104A-N. In other words, the RAS 110 processes the input from the RCMs 114A-N on a specific digital content from the respective consumers, analyzes, stores or tags into the digital content and makes the results available to the respective content service provider in real or non-real time. Further in this embodiment, the content service providers 104A-N real-time update the digital content or associated database(s) based on the received analyzed information. Also, based on the live rating, the content service providers 104A-N can adjust the digital content. For example, amongst many cameras used in a sports event, an output of a specific one may be broadcasted more than others based on rating received from the consumers. Optionally, the content service providers 104A-N can define a desired rating profile for the digital content which may be compared against an actual rating profile based on consumer inputs, live or off-line, and feedback given to the content service providers 104A-N for appropriate actions.

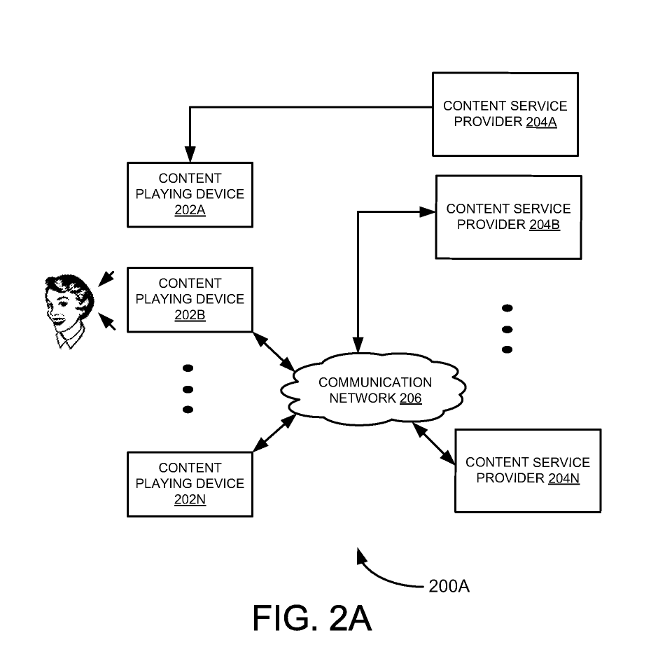

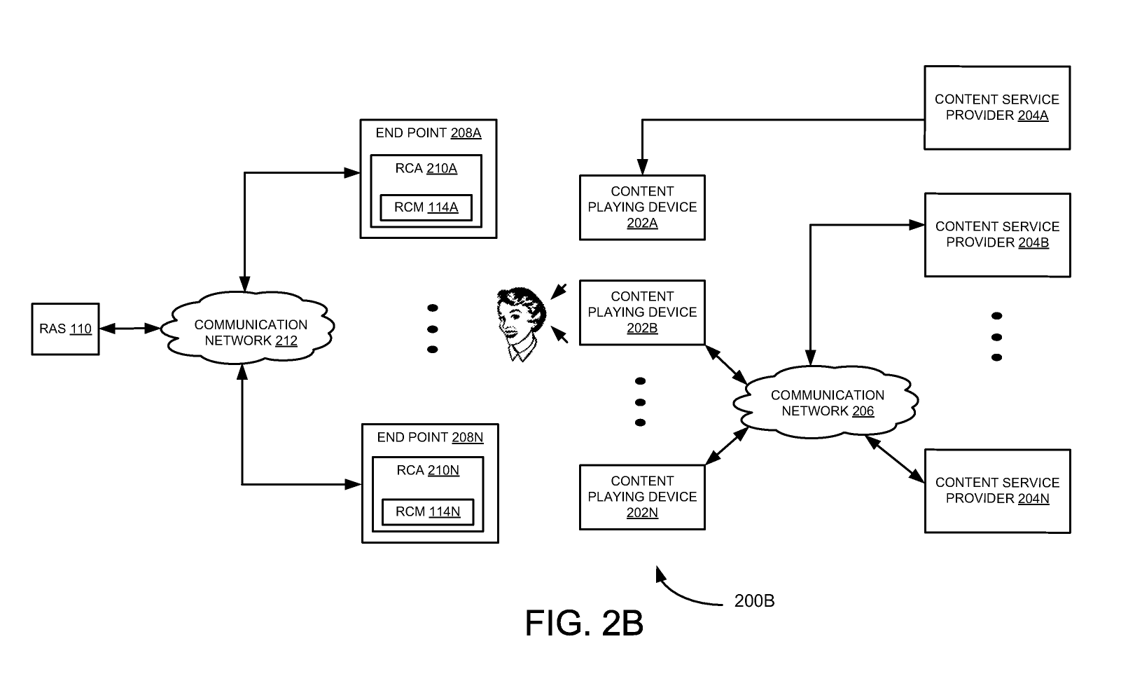

Referring now to FIG. 2A illustrates a block diagram of digital content sharing system 200A, in the context of the present invention. As shown in FIG. 2A, the system 200A includes a plurality of content playing devices 202A-N and a plurality of content service providers 204A-N. Further, the content playing devices 202A-N and the content service providers 204A-N are connected via a network including a broadcast communication network or a communication network 206. For example, the communication network 206 includes an Internet protocol (IP) network and the like. In one embodiment, the content service providers 204A-N share the digital content with the content playing devices 202A-N.

Referring now to FIG. 2B, which illustrates a block diagram of a system 200B for temporal rating and analysis of digital content, where a plurality of end points 208A-N for rating the digital content and the content service providers 204A-N are not communicatively connected, according to one embodiment. As shown in FIG. 2B, the system 200B includes the end points 208A-N, the content playing devices 202A-N, the content service providers 204A-N, and the RAS 110. For example, the end points 208A-N include a tablet, a mobile, a personal computer (PC) and the like. Exemplary content playing devices include a cable television (TV), an Internet protocol television (IPTV), a car infotainment, video conferencing and a smart TV. Further, the end points 208A-N include the RCMs 114A-N residing in rating capture applications (RCAs) 210A-N. In this embodiment, the end points 208A-N are associated with consumers of the content playing devices 202A-N. Furthermore, the end points 208A-N and the RAS 110 are communicatively connected to each other via a communication network 212. In one embodiment, the RAS 110 can be on a cloud based infrastructure and/or centralized/distributed. In addition, the content service providers 204A-N and the content playing devices 202A-N are connected via the network including the broadcast communication network or the communication network 206.

In operation, each of the content service providers 204A-N sends the digital content to the content playing devices 202A-N. Further, the RCMs 114A-N dynamically allow the consumers to provide temporal rating and/or inputs, using the end points 208A-N, while viewing and/or listening to the digital content on the content playing devices 202A-N. In one example, to encourage the consumers to rate the digital content, different forms of incentives can be extended by the content service providers including reward points and the like. In this example, the content service providers 204A-N include a cable/satellite TV services provider, the IPTV services provider, the social networking services provider, the video sharing services provider, the digital content sharing services provider, the audio/video communication/collaboration services provider and the like.

Furthermore, the RCMs 114A-N send the temporal rating and/or inputs to the RAS 110. This is explained in more detail with reference to FIG. 3. In one embodiment, some of the functionalities of the RCMs 114A-N can be alternatively and/or additionally moved to the RAS 110 where some of the temporal information about the consumption patterns can be extracted. This is explained in more detail with reference to FIG. 1B. Moreover, the RAS 110 analyzes the received temporal rating and/or inputs and then sends the analyzed information to the content service providers 204A-N. This is explained in more detail with reference to FIG. 4. For example, the RAS 110 analyzes the received temporal rating and/or inputs based on different parameters of demography of the consumers. Exemplary parameters include an area of residence, an age-group and the like. In one embodiment, the RAS 110 real-time analyzes the received temporal rating and/or inputs and sends the analyzed information to the content service providers 204A-N. Further in this embodiment, the content service providers 204A-N real-time update the digital content or associated database(s) based on the received analyzed information.

In an example scenario, a consumer is watching a television program in a channel on a cable/satellite TV and consumer's mobile phone includes a RCA. In this example, as the consumer watches the television program which is also in a content list of the RCA in the mobile, the consumer can rate the television program through the RCA. The consumer ratings are then sent to the RAS and analyzed, stored and sent to or accessed by a corresponding channel content service provider. In one scenario, the television program can also be a quiz show. In this scenario, the consumer can send an answer to a quiz question in addition to the ratings and can participate in the quiz show.

Referring now to FIG. 3, which is a block diagram 300 illustrating major functional sub-components of a RCM 114 residing in each of the end points, such as those shown in FIGS. 1B and 2B, according to one embodiment. For example, the RCM 114 is one of the RCMs 114A-N shown in FIGS. 1B and 2B. As shown in FIG. 3, the RCM 114 includes an input processing module (IPM) 302, an input integration module (IIM) 304, an output send module (OSM) 306, an input capture module (ICM) 308, a control module (CM) 310, a RAS synchronization module (RRSM) 312, a user identity module (UIM) 314, a rating criteria module (RCRM) 316, a content identity module (CIM) 318, a storage module 320 and an application programming interface (API) 322. For example, the API 322 provides software interfaces for developers to build a RCA based on the RCM 114.

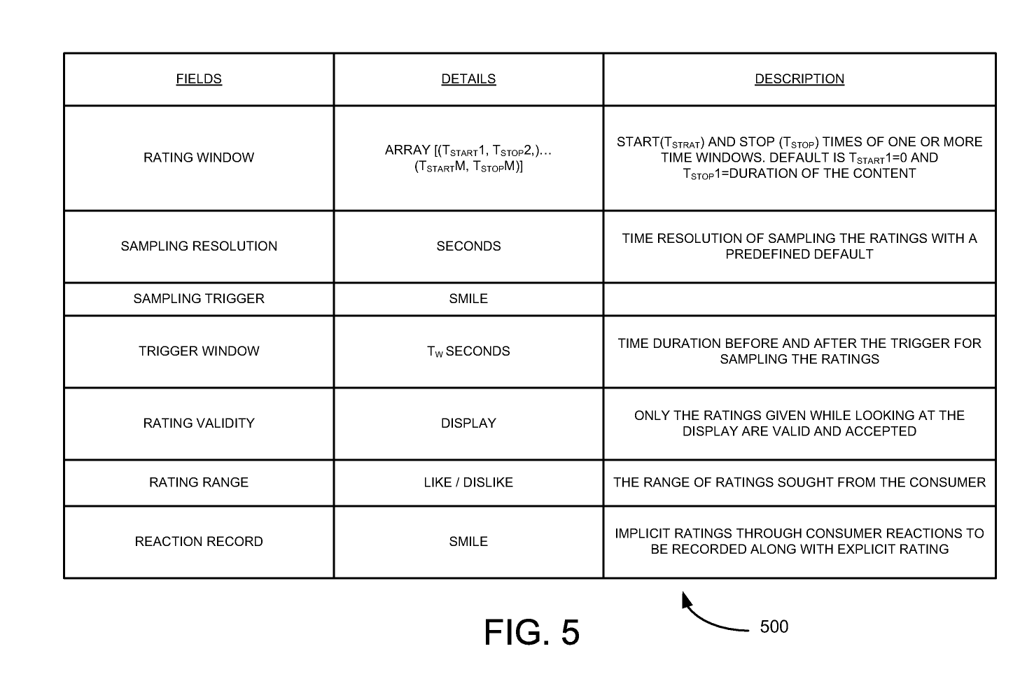

In one embodiment, the UIM 314 registers and authenticates a consumer of the end point with a RAS (e.g., the RAS 110 of FIGS. 1B and 2B) and gets authorization for use. Further, the CIM 318 captures an identifier (ID) and duration of the digital content being played, if available, or generates a unique ID, if it is not available. Furthermore, the RCRM 316 obtains a rating criteria, if available, from the RAS based on the consumer ID and digital content ID else uses a default rating criteria. For example, the rating criteria includes information on a range and granularity of the consumer rating(s), timing of window(s) of rating and/or trigger(s) to start or stop window(s), time-resolution(s) within rating window(s), time duration(s) of recording the content around the triggers, a type of processing and deductions on the qualitative inputs and the like. An example rating criteria stored in the RCRM 316 is shown in FIG. 5.

In addition, the ICM 308 takes direct quantitative inputs from the consumer through a user interface including touch, stylus, mouse and the like along with the respective time information. The ICM 308 also takes qualitative inputs through other existing peripherals as video, audio, accelerometer and the like along with the respective time information. The ICM 308 then passes the inputs in audio and/or video and/or accelerometer and all the captured inputs to the IPM 302. Moreover, the IPM 302 processes the quantitative and qualitative inputs according to its type. Exemplary processing includes eye tracking, smile detection, gesture recognition and the like for video streams and speech recognition and the like for audio streams. The IPM 302 also optionally arrives at deductions based on the processing of the qualitative inputs. Exemplary deductions are consumer looking away from a display, smile, thumbs-up or thumbs-down gesture and the like. The IPM 302 then passes the quantitative inputs and respective timelines, the qualitative inputs and respective timelines and deductions from the qualitative inputs and respective timelines to the IIM 304. The IIM 304 then integrates one or more of the processed quantitative inputs and/or qualitative inputs and/or deductions on a common time-line and passes the integrated information to the OSM 306. Optionally, the IIM 304 passes the integrated information to the storage module 320 for local storage of a rating profile for off-line access.

Also, the OSM 306 sends the integrated input information to the RAS over a communication network (e.g., the communication network 106 of FIG. 1B or the communication network 212 of FIG. 2B). Further, the RRSM 312 ensures synchronization of data, criteria and activity between the RCM 114 and the RAS. In one example, the RRSM 312 informs the RAS when the RCM 114 is invoked and by which consumer ID. Furthermore, the CM 310 controls the overall flow and coordinates between the different modules. This includes timing and resolution of capture of quantitative input and/or qualitative inputs by the ICM 308 based on the timings of the rating windows and respective resolution information in the RAS, the type of processing and deduction to be done on the qualitative input by the IPM 302, the type of inputs and deduction to be considered and integrated by the IIM 304, whether the integrated input should be recorded by the storage module 320 and the like.

Referring now to FIG. 4, which is a block diagram 400 illustrating major functional sub-components of the RAS 110, such as the one shown in FIGS. 1A and 2B, according to one embodiment. As shown in FIG. 4, the RAS 110 includes an input filter module (IFM) 402, a rating analytics module (RANM) 404, a RAS output module (RAOM) 406, an input collation module 408, a RAS and client synchronization module (RCSM) 410, a storage module 412, a content owner database (COD) 414, a content related database (CRD) 416 and a consumer content database (CCD) 418.

In one embodiment, the COD 414 contains information associated with all registered content service providers and/or people with relevant authorization. The COD 414 includes a list of digital contents owned by the content service providers and relevant information of the content service providers including a name, a user ID and a password, an email ID, contact information, an organization name, and the like. The COD 414 fields are populated by registered content service providers as and when applicable. Further, the CRD 416 contains a list of digital contents with a corresponding digital content ID, content service provider ID(s), title, description, a rating criteria, a duration of the digital content, an expected direct and/or deduced input/rating profile, numbers and IDs of active consumers at any point of time, a play out history, a collated rating profile against time and the like. Specific fields in the CRD 416 are populated by the content service providers from time to time and remaining by the system as and when applicable. Furthermore, the CCD 418 contains information associated with all registered consumers. For example, the CCD 418 includes a list of digital content IDs, a play out history, a rating history, relevant information of the consumers including a name, a user ID and a password, an email id, contact information, an organization name, and the like. Specific fields in the CCD 418 are populated by the consumers at the time of registration and the remaining fields are updated by the system as and when applicable.

In operation, the IFM 402 receives the integrated input(s) from the RCM 114, shown in FIG. 3, and filters out the integrated inputs that are invalid based on specific predefined filters. An exemplary filter rejects all direct and deduced inputs received, if the consumer is looking away from the display in case of visual content play out or speaking in case of audio content play out. Another exemplary filter can perform data consistency check to ensure incoming data integrity. For example, unintended input because of consumer error can be filtered out. Further, the input collation module 408 consolidates the filtered inputs received from the IFM 402 for a specific digital content from different consumers as they view and/or play the digital content simultaneously or at different points of time or a combination of the two. The input collation module 408 then populates the CRD 416, with the collated rating profile, with the corresponding consumer ID for each rating. Moreover, the RANM 404 analyzes the digital content rating in the CRD 416 based on predefined functions. Exemplary predefined functions include a rating profile across demography, expected rating vis-à-vis actual rating and the like. In addition, the RCSM 410 and a RRSM (e.g., the RRSM 312 of FIG. 3) ensures synchronization between the RAS 110 and the RCM 114. In one example, the RCSM 410 and the RRSM dynamically synchronize the RAS 110 and the RCM 114. An exemplary dynamic synchronization can happen when the content service providers of the digital content changes the rating criteria and the like, in real-time, based on a live rating profile and instructs the RAS 110 to synchronize the updated criteria with all the end points. Also, the RAOM 406 generates off-line or live data in both machine and human readable form for live or off-line consumption which can optionally be archived in the storage module 412. The content service providers can access the information by logging on to the RAS 110 and/or receive the information from the RAS 110 in real-time or otherwise.

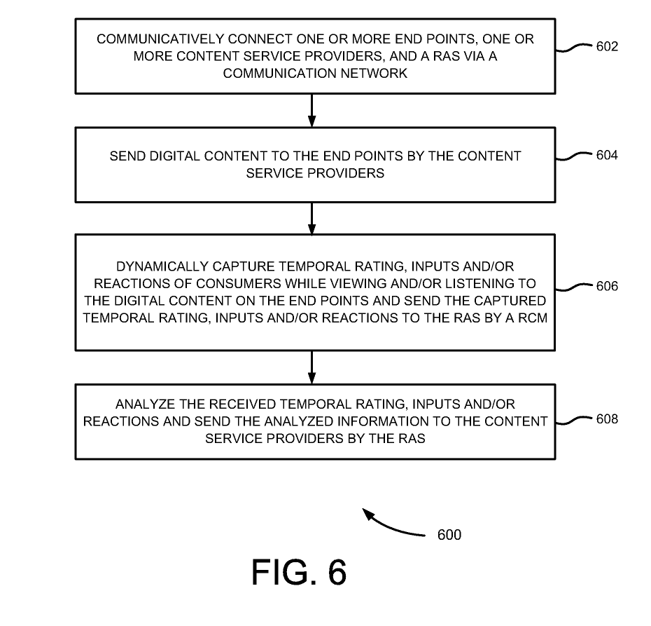

Referring now to FIG. 6, which illustrates a process flow 600 for temporal rating and analysis of digital content, according to one embodiment. At block 602, one or more end points, one or more content service providers, and a RAS are communicatively connected via a communication network. In one example, each of the end points includes a RCM. At block 604, the digital content is sent to the end points, for play out, by the content service providers. At block 606, temporal rating, inputs and/or reactions of consumers are dynamically captured, by the RCM, while viewing and/or listening to digital content on the end points. Further, the captured temporal rating, inputs and/or reactions are dynamically sent to the RAS by the RCM. At block 608, the received temporal rating, inputs and/or reactions are analyzed and sent to the content service providers by the RAS. This is explained in more detail with reference to FIG. 1B.

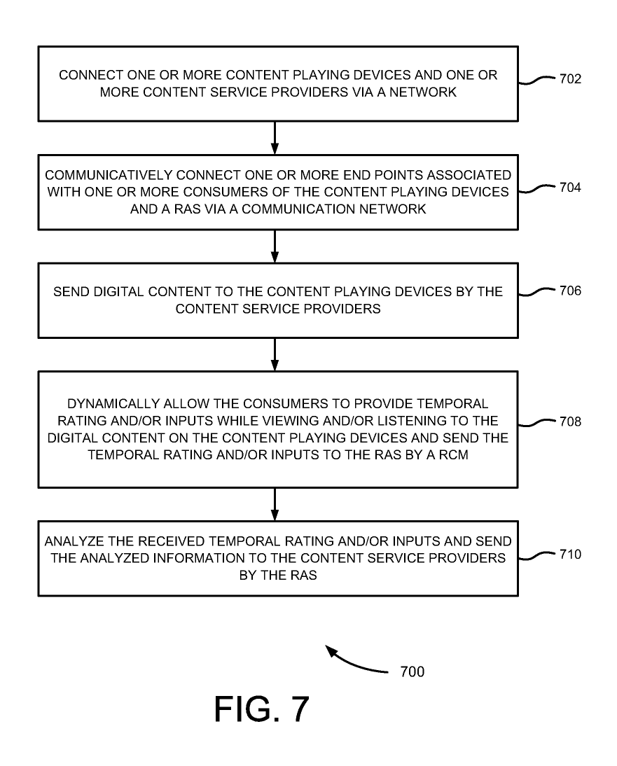

Referring now to FIG. 7, which illustrates another process flow 700 for temporal rating and analysis of digital content, according to one embodiment. At block 702, one or more content playing devices and one or more content service providers are connected via a network. At block 704, one or more end points associated with one or more consumers of the content playing devices and a RAS are communicatively connected via a communication network. In one embodiment, the end points are not communicatively connected to the content service providers. In one example embodiment, each of the end points includes a RCM residing in a RCA. At block 706, the digital content is sent to the content playing devices, for play out, by the content service providers. At block 708, the consumers are dynamically allowed to provide temporal rating and/or inputs while viewing and/or listening to the digital content on the content playing devices, by the RCM. Further, the temporal rating and/or inputs are dynamically sent to the RAS by the RCM. At block 710, the received temporal rating and/or inputs are analyzed and sent to the content service providers by the RAS. This is explained in more detail with reference to FIG. 2B.

In one embodiment, an article comprising a non-transitory computer readable storage medium having instructions thereon which when executed by a computing platform result in execution of the above mentioned method. The method described in the foregoing may be in a form of a machine-readable medium embodying a set of instructions that, when executed by a machine, causes the machine to perform any method disclosed herein. It will be appreciated that the various embodiments discussed herein may not be the same embodiment, and may be grouped into various other embodiments not explicitly disclosed herein.

In various embodiments, the systems and methods described in FIGS. 1B, 2B-7 propose a technique in which the RCM directly or indirectly captures the consumer temporal rating, inputs and/or reactions on the digital content while viewing and/or listening to the digital content and sends the captured information to the RAS. Further, the RAS analyzes, real-time or non real-time, the received information and sends the analyzed information to the content service providers. Furthermore, the content service providers update the digital content, in real-time, based on the received information. Thus, the above technique is sufficient for a temporally changing digital content environment.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, comprising:
communicatively connecting one or more end points, one or more content service providers, and a rating analytics server (RAS) via a communication network, wherein each of the one or more end points includes a rating capture module (RCM);
sending digital content to the one or more end points by the one or more content service providers;
dynamically capturing temporal rating, inputs and/or reactions of consumers while viewing and/or listening to the digital content on the one or more end points and sending the captured temporal rating, inputs and/or reactions to the RAS by the RCM; and
analyzing the received temporal rating, inputs and/or reactions and sending the analyzed information to the one or more content service providers by the RAS.

2. The method of claim 1, wherein analyzing the received temporal rating, inputs and/or reactions and sending the analyzed information to the one or more content service providers by the RAS, comprises:
real-time analyzing the received temporal rating, inputs and/or reactions and sending the analyzed information to the one or more content service providers by the RAS.

3. The method of claim 2, further comprising:
real-time updating the digital content or associated database(s) of the corresponding content service providers based on the received analyzed information.

4. The method of claim 1, wherein the received temporal rating, inputs and/or reactions are analyzed by the RAS based on different parameters of demography of the consumers and wherein the parameters include an area of residence and/or an age-group.

5. The method of claim 1, wherein the RCM is integrated into a standalone application or into content player applications in each of the one or more end points.

6. The method of claim 1, wherein the digital content includes audio streams, video streams, text, images, and graphics.

7. The method of claim 1, wherein the one or more end points are selected from the group consisting of a tablet, a mobile, a personal computer (PC), and appliances, machines and gadgets (AMGs) with content consumption.

8. The method of claim 1, wherein the RCM comprises a user identity module (UIM) for registering and authenticating the consumers with the RAS, wherein the RCM further comprises a content identification module (CIM) for capturing an identifier (ID) and duration of the digital content being played, if available, or for generating a unique ID, wherein the RCM further comprises a rating criteria module (RCRM) for obtaining a rating criteria from the RAS based on consumer IDs and the digital content IDs and wherein the rating criteria includes information on a range and granularity of the consumer rating(s), timing of window(s) of rating and/or trigger(s) to start or stop window(s), time-resolution(s) within rating window(s), time duration(s) of recording the digital content around the triggers, and a type of processing and deductions on qualitative inputs.

9. The method of claim 8, wherein the RCM further comprises an input capture module (ICM) for taking direct quantitative and qualitative inputs from the consumers along with respective time information through user interfaces and peripherals, respectively, wherein the RCM further comprises an input processing module (IPM) for processing the quantitative and qualitative inputs according to its type and optionally arriving at deductions based on the processing of the qualitative inputs, wherein the RCM further comprises an input integration module (IIM) for integrating one or more of the processed quantitative and/or qualitative inputs and/or deductions on a common time-line and wherein the RCM further comprises a storage module for optionally storing the processed quantitative and/or qualitative inputs and/or deductions for local storage.

10. The method of claim 9, wherein the RCM further comprises an output send module (OSM) for sending the integrated input information to the RAS via the communication network, wherein the RCM further comprises a RAS synchronization module (RRSM) for ensuring synchronization of data, criteria and activity between the RCM and the RAS and wherein the RCM further comprises a control module (CM) for controlling overall flow and co-ordinates between the different modules.

11. The method of claim 1, wherein the RAS comprises a content owner database (COD) for storing information associated with all registered content service providers and/or people with relevant authorization, wherein the RAS further comprises a content related database (CRD) for storing a list of digital contents with corresponding content information and consumer information and wherein the RAS further comprises a content consumer database (CCD) for storing information associated with all registered consumers.

12. The method of claim 11, wherein the RAS further comprises an input filter module (IFM) for receiving integrated inputs from the RCM and filtering out the integrated inputs that are invalid based on specific predefined filters, wherein the RAS further comprises an input collation module for consolidating the filtered inputs received from the IFM for a specific digital content from different consumers, wherein the input collation module further populates the CRD, with a collated rating profile, with the corresponding consumer identifier (ID) for each rating, and wherein the RAS further comprises a rating analytics module (RANM) for analyzing the digital content rating in the CRD based on predefined functions.

13. The method of claim 12, wherein the RAS further comprises a RAS and client synchronization module (RCSM) for ensuring synchronization between the RCM and the RAS, wherein the RAS further comprises a RAS output module (RAOM) for generating off-line or live data for live or off-line consumption and wherein the RAS further comprises a storage module for optionally archiving the generated off-line or live data.

14. A method, comprising:
connecting one or more content playing devices and one or more content service providers via a network;
communicatively connecting one or more end points associated with one or more consumers of the one or more content playing devices and a rating analytics server (RAS) via a communication network, wherein the one or more end points are not communicatively connected to the one or more content service providers and wherein each of the one or more end points comprises a rating capture application (RCA) including a rating capture module (RCM);
sending digital content to the one or more content playing devices by the one or more content service providers;
dynamically allowing the consumers to provide temporal rating and/or inputs while viewing and/or listening to the digital content on the one or more content playing devices and sending the temporal rating and/or inputs to the RAS by the RCM; and
analyzing the received temporal rating and/or inputs and sending the analyzed information to the one or more content service providers by the RAS.

15. The method of claim 14, wherein analyzing the received temporal rating and/or inputs and sending the analyzed information to the one or more content service providers by the RAS, comprises:
real-time analyzing the received temporal rating and/or inputs and sending the analyzed information to the one or more content service providers by the RAS.

16. The method of claim 15, further comprising:
real-time updating the digital content or associated database(s) of the corresponding content service providers based on the received analyzed information.

17. The method of claim 16, wherein the content service providers include a cable/satellite television (TV) services provider, an Internet protocol television (IPTV) services provider, a social networking services provider, a video sharing services provider, a digital content sharing services provider, and an audio/video communication/collaboration services provider.

18. The method of claim 14, wherein the network includes a broadcast communication network and/or an Internet protocol (IP) network.

19. The method of claim 14, wherein the one or more content playing devices are selected from the group consisting of a cable television (TV), an Internet protocol television (IPTV), a car infotainment, video conferencing and a smart TV.

20. A system, comprising:
one or more content service providers;
one or more end points, wherein each of the one or more end points comprises a rating capture module (RCM); and
a rating analytics server (RAS), wherein the one or more end points, the one or more content service providers, and the RAS are communicatively connected via a communication network, wherein the one or more content service providers send digital content to the one or more end points, wherein the RCM dynamically captures temporal rating, inputs and/or reactions of consumers while viewing and/or listening to the digital content on the one or more end points and sends the captured temporal rating, inputs and/or reactions to the RAS, and wherein the RAS analyzes the received temporal rating, inputs and/or reactions and sends the analyzed information to the one or more content service providers.

21. The system of claim 20, wherein the RAS is configured to:
real-time analyze the received temporal rating, inputs and/or reactions and send the analyzed information to the one or more content service providers.

22. The system of claim 21, wherein the one or more content service providers further real-time update the digital content or associated database(s) based on the received analyzed information.

23. The system of claim 20, wherein the RCM comprises a user identity module (UIM) for registering and authenticating the consumers with the RAS, wherein the RCM further comprises a content identification module (CIM) for capturing an identifier (ID) and duration of the digital content being played, if available, or for generating a unique ID, wherein the RCM further comprises a rating criteria module (RCRM) for obtaining a rating criteria from the RAS based on consumer IDs and the digital content IDs and wherein the rating criteria includes information on a range and granularity of the consumer rating(s), timing of window(s) of rating and/or trigger(s) to start or stop window(s), time-resolution(s) within rating window(s), time duration(s) of recording the digital content around the triggers, and a type of processing and deductions on qualitative inputs.

24. The system of claim 23, wherein the RCM further comprises an input capture module (ICM) for taking direct quantitative and qualitative inputs from the consumers along with respective time information through user interfaces and peripherals, respectively, wherein the RCM further comprises an input processing module (IPM) for processing the quantitative and qualitative inputs according to its type and optionally arriving at deductions based on the processing of the qualitative inputs, wherein the RCM further comprises an input integration module (IIM) for integrating one or more of the processed quantitative and/or qualitative inputs and/or deductions on a common time-line and wherein the RCM further comprises a storage module for optionally storing the processed quantitative and/or qualitative inputs and/or deductions for local storage.

25. The system of claim 24, wherein the RCM further comprises an output send module (OSM) for sending the integrated input information to the RAS via the communication network, wherein the RCM further comprises a RAS synchronization module (RRSM) for ensuring synchronization of data, criteria and activity between the RCM and the RAS and wherein the RCM further comprises a control module (CM) for controlling overall flow and co-ordinates between the different modules.

26. The system of claim 20, wherein the RAS comprises a content owner database (COD) for storing information associated with all registered content service providers and/or people with relevant authorization, wherein the RAS further comprises a content related database (CRD) for storing a list of digital contents with corresponding content information and consumer information and wherein the RAS further comprises a content consumer database (CCD) for storing information associated with all registered consumers.

27. The system of claim 26, wherein the RAS further comprises an input filter module (IFM) for receiving integrated inputs from the RCM and filtering out the integrated inputs that are invalid based on specific predefined filters, wherein the RAS further comprises an input collation module for consolidating the filtered inputs received from the IFM for a specific digital content from different consumers, wherein the input collation module further populates the CRD, with a collated rating profile, with the corresponding consumer identifier (ID) for each rating, and wherein the RAS further comprises a rating analytics module (RANM) for analyzing the digital content rating in the CRD based on predefined functions.

28. The system of claim 27, wherein the RAS further comprises a RAS and client synchronization module (RCSM) for ensuring synchronization between the RCM and the RAS, wherein the RAS further comprises a RAS output module (RAOM) for generating off-line or live data for live or off-line consumption and wherein the RAS further comprises a storage module for optionally archiving the generated off-line or live data.

29. A system, comprising:
one or more content service providers;
one or more content playing devices;
one or more end points associated with one or more consumers of the one or more content playing devices, wherein each of the one or more end points comprises a rating capture application (RCA) including a rating capture module (RCM); and
a rating analytics server (RAS), wherein the one or more content playing devices and the one or more content service providers are connected via a network, wherein the one or more end points and the RAS are communicatively connected via a communication network, wherein the one or more end points are not communicatively connected to the one or more content service providers, wherein the one or more content service providers send digital content to the one or more content playing devices, wherein the RCM dynamically allows the consumers to provide temporal rating and/or inputs while viewing and/or listening to the digital content on the one or more content playing devices and sends the temporal rating and/or inputs to the RAS and wherein the RAS analyzes the received temporal rating and/or inputs and sends the analyzed information to the one or more content service providers.

30. The system of claim 29, wherein the RAS is configured to:
real-time analyze the received temporal rating and/or inputs and send the analyzed information to the one or more content service providers.

31. The system of claim 30, wherein the one or more content service providers further real-time update the digital content or associated database(s) based on the received analyzed information.

32. A non-transitory computer-readable storage medium having instructions that when executed by a computing device, cause the computing device to:
communicatively connect one or more end points, one or more content service providers, and a rating analytics server (RAS) via a communication network, wherein each of the one or more end points includes a rating capture module (RCM);
send digital content to the one or more end points by the one or more content service providers;
dynamically capture temporal rating, inputs and/or reactions of consumers while viewing and/or listening to the digital content on the one or more end points and send the captured temporal rating, inputs and/or reactions to the RAS by the RCM; and
analyze the received temporal rating, inputs and/or reactions and send the analyzed information to the one or more content service providers by the RAS.

33. The non-transitory computer-readable storage medium of claim 32, wherein the instructions cause the computing device to:
real-time analyze the received temporal rating, inputs and/or reactions and send the analyzed information to the one or more content service providers by the RAS.

34. The non-transitory computer-readable storage medium of claim 33, wherein the instructions further cause the computing device to:
real-time update the digital content or associated database(s) of the corresponding content service providers based on the received analyzed information.

35. A non-transitory computer-readable storage medium having instructions that when executed by a computing device, cause the computing device to:
connect one or more content playing devices and one or more content service providers via a network;
communicatively connect one or more end points associated with one or more consumers of the one or more content playing devices and a rating analytics server (RAS) via a communication network, wherein the one or more end points are not communicatively connected to the one or more content service providers and wherein each of the one or more end points comprises a rating capture application (RCA) including a rating capture module (RCM);
send digital content to the one or more content playing devices by the one or more content service providers;
dynamically allow the consumers to provide temporal rating and/or inputs while viewing and/or listening to the digital content on the one or more content playing devices and send the temporal rating and/or inputs to the RAS by the RCM; and
analyze the received temporal rating and/or inputs and send the analyzed information to the one or more content service providers by the RAS.

36. The non-transitory computer-readable storage medium of claim 35, wherein the instructions cause the computing device to:
real-time analyze the received temporal rating, inputs and/or reactions and send the analyzed information to the one or more content service providers by the RAS.

37. The non-transitory computer-readable storage medium of claim 36, wherein the instructions further cause the computing device to:
real-time update the digital content or associated database(s) of the corresponding content service providers based on the received analyzed information.
